(19) United States
(12) Patent Application Publication
(10) Pub. No.: US 2023/0010170 A1
(43) Pub. Date: Jan. 12, 2023

(54) METHOD OF STANDBY POWER SUPPLY

(71) Applicant: INNO-TECH CO., LTD., Taipei City (TW)

(72) Inventors: Shu-Chia Lin, Taipei City (TW); Tsu-Huai Chan, Taipei City (TW); Chih-Feng Lin, Taipei City (TW)

(21) Appl. No.: 17/838,306

(22) Filed: Jun. 13, 2022

(30) Foreign Application Priority Data
Jul. 8, 2021 (TW) 110125195

(51) Int. Cl. H02M 3/335; H02M 1/00

(52) U.S. Cl. CPC H02M 3/33592; H02M 1/0009; H02M 1/4208

(57) ABSTRACT

The present invention discloses a method of standby power supply including steps of: detecting a loading level; determining the loading level; entering a select mode; selecting a standby mode; entering a no-load mode, or a sleep mode, or a power-down mode; during the no-load mode, generating a no-load sustaining power, and returning back to detect the loading level when a preset condition is met; during the sleep mode, generating a sleep sustaining power, and returning back to detect the loading level when the preset condition is met; during the power-down mode, ceasing the power and entering a power-down recovery mode; and during the power-down recovery mode, returning back to detect the loading level when the preset condition is met. Therefore, the present invention implements power conversion for normal power supply, and particularly effectively controls the amount of power in the standby state, thereby greatly reducing power consumption and improving power saving.

### CROSS-REFERENCE TO RELATED APPLICATION

This application claims the priority of Taiwanese patent application No. 110125195, filed on Jul. 8, 2021, which is incorporated herewith by reference.

### BACKGROUND OF THE INVENTION

### 1. Field of the Invention

The present invention generally relates to a method of power supply, and particularly to a method of standby power supply employing a power conversion system to generate and deliver an operation power as an output power, and selecting a no-load mode, a sleep mode, or a power-down mode as a standby mode through a primary side digital controller in a standby state to control the output power, thereby effectively reducing power consumption in the standby state and greatly improving efficiency of power conversion.

### 2. The Prior Arts

Since different electronic devices often require specific power to operate, power conversion devices with high quality and efficiency are greatly needed to serve as power supply. For example, a traditional integrated circuit (IC) needs 1.2V low direct current (DC) power, and electric motors commonly employs 12V DC power, but the back light module usually takes much higher voltage power like up to several hundred voltages. Among the current power supply devices, switching power supply employing a pulse width modulation (PWM) scheme is widely used because of its smaller size than the linear power supply for the same output power, and higher efficiency of power conversion.

Take the flyback power supply as an example. The power controller is included to generate the PWM driving signal with high frequency, and a switch unit, a current sensing resistor, an output rectifier, an output capacitor, and a transformer comprising a primary side winding and a secondary side winding are also in collocation. Specifically, the primary side winding, the switch unit, and the current sensing resistor are connected in series to form a primary side loop, and the secondary side winding, the output rectifier, and the output capacitor of the transformer are connected in series to form a secondary side loop. In addition, the PWM driving signal is intended to drive the switch unit connected to the primary side winding like a power transistor. The switch unit is quickly and periodically turned on and off to conduct and cut off the current flowing through the switch unit to induce a secondary side current flowing through the secondary side winding due to electromagnetic interaction between the secondary side winding and the primary side winding. The secondary side current further flows through the output rectifier and the output capacitor for rectification and filtration to generate the stable output power supplying the load to operate.

The output rectifier in the primary side loop can be implemented by a rectification diode in collocation with the output capacitor, or a secondary side switch unit and a secondary side controller in collocation with the output capacitor to achieve rectification, especially synchronous rectification because of the secondary side controller.

As people are more concerned about environmental protection and carbon reduction, the manufactures have endeavored to save precious power wasted by electric and electronic devices like standby power, and various test requirements and protocols have been established. In particular, the test requirements become more critical and strict.

However, one shortcoming in the prior arts is that the above scheme cannot be directly applied to some common switching power supply devices such as the flyback power converter. Further, the current power supply usually enters the burst mode or the skip mode in case of no-load to decrease the PWM frequency so as to save standby power with few PWM pulses, and the output power is kept within the preset range, but the 90-264 Vac input power still keeps supplying the power. As a result, waste of power happens. To this, some primary side controller IC cuts off the input power of high voltage just after powering on, and thus totally stops power supply. However, this feature takes extremely advanced semiconductor technology for manufacturing the ultra-high voltage IC to implement, and the cost greatly increases, the IC produced failing to compete in the market.

Therefore, it is greatly needed to provide a new method of standby power supply employing the scheme similar to a traditional digital controller to directly enter the power-down mode to cut off the output power when the system does not need to keep the output voltage and sustains at the standby state like a smartphone without a charger pad connected to the socket. Also, the method may enter the sleep mode when the system needs to keep the required output voltage at the standby state, or the method may enter the no-load mode for further saving power in case of no power required by the system. In particular, the system is waked up from the power-down mode, the sleep mode the no-load mode to return back to the normal mode. The present invention effectively reduces overall power consumption and greatly improves the efficiency of power saving, thereby overcoming the above problems in the prior arts.

### SUMMARY OF THE INVENTION

The primary object of the present invention provides a method of standby power supply comprising the steps S10, S20, S30, S40, S50, S52, S54, S56, S60, S62, S64, S66, S70, S72, S74, and S76 to implement power conversion and power supply for standby, thereby effectively reducing power consumption in the standby state and greatly improving efficiency of power conversion.

Specifically, the method of the present invention begins at the step S10 by employing a power conversion system to generate and deliver an operation power as an output power through an output power terminal of the power conversion system, and detecting a loading level applied to the output power terminal. It should be noted that the output power terminal is connected to a load or not.

Then the step S20 is performed after the step S10 by determining the loading level and a period of time as a standby sustaining time when the loading level is not greater than a standby loading, and also examining if the standby sustaining time reaches a standby time. For example, the standby loading is 1 to 5% of a full loading, and the standby time is 0.1 to 10 milliseconds. If the loading level is not greater than the standby loading and the standby sustaining time reaches the standby time in the step S20, the step S30 is performed by entering a select mode.

The step S40 is performed after the step S30 by checking if a load is connected to the output power terminal or the load is disconnected from the output power terminal, further determining if the load connected has a standby power requirement, and selecting a no-load mode, a sleep mode, or a power-down mode as a standby mode. Specifically, the no-load mode is selected when the load is not connected to or disconnected from the output power terminal, the sleep mode is selected when the load connected has the standby power requirement, and the power-down mode is selected when the load connected does not have the standby power requirement.

The step S50 is performed after the step S40 to execute the no-load mode when the load is not connected to or disconnected from the output power terminal. Then, the step S52 is performed after the step S50 by driving the power conversion system to generate and deliver a no-load sustaining power to the output power terminal, and the step S54 is performed to execute a no-load wake-up detecting mode to detect if the loading level is not less than a no-load wake-up level. When the loading level is not less than the no-load wake-up level and sustains for more than a no-load wake-up time, the step S56 is performed after the step S54 by driving the power conversion system to generate and deliver the operation power, and then returning back to the step S10.

For example, the no-load sustaining power is 0.1 to 10% of the operation power, the no-load wake-up level is 1 to 5% of the full loading, and the no-load wake-up time is 1 to 10 seconds.

In additional, the step S60 is performed after the step S40 by executing the sleep mode when the load connected has the standby power requirement. The step S62 is performed after the step S60 by driving the power conversion system to generate and deliver a sleep sustaining power less than the operation power to the output power terminal so as to meet the requirement of standby power, and then entering the step S64. In the step S60, a sleep wake-up detecting mode is performed to detect if the loading level is not less than a sleep wake-up level. If the loading level is not less than the sleep wake-up level and sustains for more than a sleep wake-up time, the step S66 is performed by executing a sleep recovery mode to drive the power conversion system to generate and deliver the operation power, and then return back to the step S10.

For example, the sleep sustaining power is not less than the no-load sustaining power, the sleep wake-up level is 1 to 5% of the full loading, and the sleep wake-up time is 1 to 10 seconds.

Further, the step S70 is performed after the step S40 by executing the power-down mode when the load connected does not have the standby power requirement, and the step S72 is performed after the step S70 by ceasing the operation power to the output power terminal, and entering a power-down wake-up detecting mode, and entering a power-down wake-up detecting mode, The step S74 is performed after the step S72 by executing the power-down wake-up detecting mode to detect if the loading level is not less than a power-down wake-up level. If the loading level is not less than the power-down wake-up level and sustains for more than a power-down wake-up time, a power-down recovery mode is performed in the step S76 to drive the power conversion system to generate and deliver the operation power, and then return back to the step S10.

For example, the power-down wake-up level is 1 to 5% of the full loading, and the power-down wake-up time is 1 to 10 seconds.

More specifically, the above power conversion system can be implemented by a flyback power conversion system with synchronous rectification comprising a primary side digital controller, a secondary side digital controller, a rectification unit, a power unit, a transformer unit, a primary side switch unit, a current sensing unit, a secondary side switch unit, and a secondary side output capacitor. In particular, the primary side digital controller is configured to perform the steps S10, S20, S30, S40, S50, S52, S54, S56, S60, S62, S64s S66, S70, S72, S74, and S76, and has a primary side power pin, a primary side ground pin, a primary side driving pin, and a primary side current sending pin. The primary side ground pin is connected to a primary side ground level.

Or alternatively, the above power conversion system can be implemented by a flyback power conversion system without synchronous rectification comprising a primary side digital controller, a rectification unit, a power unit, a transformer unit, a primary side switch unit, a secondary side output capacitor, a secondary side rectification diode, and a current sensing unit without a secondary side digital controller and a secondary side switch unit, but replacing the secondary side switch unit by secondary side rectification diode. Also, the primary side digital controller is configured to perform the steps SI0, S20, S30, S40, S50, S52, S54, S56, S60, S62, S64, S66, S70, S72, S74, and S76, and has a primary side power pin, a primary side ground pin, a primary side driving pin, and a primary side current sensing pin. The primary side ground pin is connected to a primary side ground level.

For the flyback power conversion system with synchronous rectification, the rectification unit receives an external input power to generate and deliver a rectification power through rectification, and the power unit receives the external input power to generate a power voltage. The primary side power pin is connected to the power unit for receiving the power voltage to supply the primary side digital controller. The transformer unit comprises a primary side winding and a secondary side winding electromagnetically coupled together, an end of the primary side winding connected to the rectification unit for receiving the rectification power. The drain of the primary side switch unit is connected to the other end of the primary side winding, and the gate of the primary side switch unit is connected to the primary side driving pin.

An end of the current sensing unit is connected to the primary side current sensing pin and the source of the primary side switch unit, and the other end of the current sensing unit is connected to the primary side ground level. The primary side current sensing pin generates and delivers a current sensing signal to the primary side digital controller through the primary side current sensing pin. Additionally, the drain of the secondary side switch unit is connected to an end of the secondary side winding, an end of the secondary side output capacitor and an end of the load are connected to the source of the secondary side switch unit, and the gate of the secondary side switch unit is connected to the secondary side driving pin. The other end of the secondary side winding, the other end of the secondary side output capacitor and the other end of the load are connected to the secondary side ground level. In particular, the source of the secondary side switch unit serves as the output power terminal and generates the output power to supply the load.

Further, the primary side digital controller receives the current sensing signal through the primary side current sensing pin to generate and deliver a primary side driving signal to the gate of the primary side switch unit through the primary side driving pin. The primary side driving signal is substantially a Pulse Width Modulation (PWM) signal with a PWM frequency, and has a turn-on level and a turn-off level periodically interlacing for periodically turning on and off the primary side switch unit to change a primary side current flowing through the primary side winding.

Also, the secondary side digital controller employs the secondary side current or the drain-source voltage of the secondary side switch unit to generate the secondary side power voltage, and the secondary side power voltage is delivered to the gate of the secondary side switch unit through the secondary side driving pin so as to control the secondary side switch unit to turn on and off. Particularly, the secondary side winding generates a secondary side current by electromagnetic interaction with the primary side winding, the secondary side current flows through the secondary side switch unit to the secondary side output capacitor and the load, and the secondary side output capacitor and the load are connected in parallel and then connected in series to the secondary side switch unit.

For the flyback power conversion system without synchronous rectification, the primary side digital controller employed is the same as the primary side digital controller in the flyback power conversion system with synchronous rectifications and also has the same circuit features for the corresponding electric elements.

Further, a positive end of the secondary side rectification diode is connected to an end of the secondary side winding, and an end of the secondary side output capacitor and an end of the load are connected to a negative end of the secondary side rectification diode. The other end of the secondary side winding, the other end of the secondary side output capacitor, and the other end of the load are connected to a secondary side ground level, particularly, the negative end of the secondary side rectification diode generating the output power for supplying the load.

Therefore, the method of the present invention is feasible for the flyback power conversion system with synchronous rectification and the flyback power conversion system without synchronous rectification to implement power conversion as well as capable of reducing power consumption in standby state to greatly improve power saving.

As a whole, the present invention determines to enter the standby mode based on the loading level so as to select the no-load mode, the sleep mode, or the power-down mode for standby, and the power conversion system is controlled to deliver the no-load sustaining power or the sleep sustaining power, or just cease the output power to the output power terminal. The no-load wake-up detection mode, the sleep wake-up detection mode, and the power-down wake-up detection mode are further provided to return back to the normal operation mode from the no-load mode, the sleep mode, and the power-down mode.

However, the present invention is not limited to the flyback power conversion system, but applicable to other power conversion systems controlled by a digital controller in collocation with some inductive elements such as boost power conversion system, buck power conversion system, buck-boost conversion system, and power factor correction (PFC) power conversion system.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart showing the method of standby power supply according to the embodiment of the present invention;

FIG. 2 is a view showing the functional blocks of the power conversion system employed by the method according to the embodiment of the present invention;

FIG. 3 is another view showing the functional blocks of the power conversion system employed by the method according to the embodiment of the present invention;

FIG. 4 is another view showing the functional blocks of the power conversion system employed by the method according to the embodiment of the present invention;

FIG. 5 is another view showing the functional blocks of the power conversion system employed by the method according to the embodiment of the present invention; and

FIG. 6 is another view showing the functional blocks of the power conversion system employed by the method according to the embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

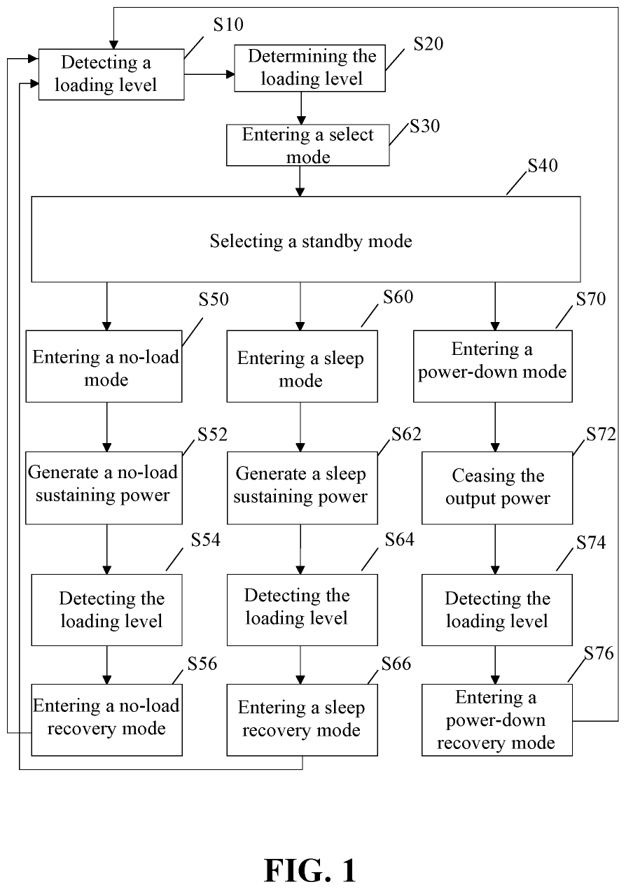

Please refer to FIG. 1 showing the method of standby power supply according to the embodiment of the present invention. As shown in FIG. 1, the method of standby power supply of the present invention generally comprises the steps S10, S20, S30, S40, S50, S52, S54, S56, S60, S62, S64, S66, S70, S72, S74, and S76 to implement power conversion and provide appropriate standby power. In particular, the method of the present invention employs the wake-up scheme to determine whether to recover the normal power supply so as to achieve power saving and avoid wasting precious power.

Specifically, the method of standby power supply of the present invention begins at the step S10 to detect a loading level applied to the output power terminal while a power conversion system generates and delivers an operation power as an output power through an output power terminal of the power conversion system.

The step S20 is performed after the step S10 by determining the loading level and a period of time as a standby sustaining time when the loading level is not greater than a standby loading, and also examining if the standby sustaining time reaches a standby time. If the loading level is not greater than the standby loading and the standby sustaining time reaches the standby time in the step S20, the step S30 is performed by entering a select mode.

The step S40 is performed after the step S30 by checking if a load is connected to the output power terminal or the load is disconnected from the output power terminal, further determining if the load connected has a standby power requirement, and then selecting a no-load mode, a sleep mode, or a power-down mode as a standby mode. Further, the no-load mode is selected when the load is not connected to or disconnected from the output power terminal, the sleep mode is selected when the load connected has the standby power requirement, and the power-down mode is selected when the load connected does not have the standby power requirement.

The step S50 is performed after the step S40 to execute the no-load mode (or so-called deep sleep mode) when the load is not connected to or disconnected from the output power terminal. Then, the step S52 is per formed after the step S50 by driving the power conversion system to generate and deliver a no-load sustaining power less than the operation power to the output power terminal, and the step S54 is performed to execute a no-load wake-up detecting mode to detect if the loading level is not less than a no-load wake-up level. When the loading level is not less than the no-load wake-up level and sustains for more than a no-load wake-up time, the step S56 is performed after the step S54 by driving the power conversion system to generate and deliver the operation power, and then returning back to the step S10.

Furthermore, the step S60 is performed after the step S40 by executing the sleep mode when the load connected has the standby power requirement. The step S62 is performed after the step S60 by driving the power conversion system to generate and deliver a sleep sustaining power less than the operation power to the output power terminal so as to meet the requirement of standby power, and then entering the step S64. In the step S60, a sleep wake-up detecting mode is performed to detect if the loading level is not less than a sleep wake-up level. If the loading level is not less than the sleep wake-up level and sustains for more than a sleep wake-up time, the step S66 is performed by executing a sleep recovery mode to drive the power conversion system to generate and deliver the operation power, and then return back to the step S10.

Also, the step S70 is performed after the step S40 by executing the power-down mode when the load connected does not have the standby power requirement, and the step S72 is performed after the step S70 by ceasing the operation power to the output power terminal, and entering a power-down wake-up detecting mode, and entering a power-down wake-up detecting mode”, The step S74 is performed after the step S72 by executing the power-down wake-up detecting mode to detect if the loading level is not less than a power-down wake-up level. If the loading level is not less than the power-down wake-up level and sustains for more than a power-down wake-up time, a power-down recovery mode is performed in the step S76 to drive the power conversion system to generate and deliver the operation power, and then return back to the step S10.

It is preferred that the standby loading is 1 to 5% of a full loading, the standby time is 0.1 to 10 milliseconds, the no-load sustaining power is 0.1 to 10% of the operation power, the sleep sustaining power is not less than the no-load sustaining power, the no-load wake-up level is 1 to 5% of the full loading, the sleep wake-up level is 1 to 5% of the full loading, the power-down wake-up level is 1 to 5% of the full loading, the no-load wake-up time is 1 to 10 seconds, the sleep wake-up time is 1 to 10 seconds, and the power-down wake-up time is 1 to 10 seconds. The above examples are only illustrative and not intended to limit the scope of the present invention.

It should be noted that the method of standby power supply of the present invention is applicable to the flyback power conversion system with synchronous rectification as well as the flyback power conversion system without synchronous rectification, and further suitable for other power conversion systems controlled by a digital controller in collocation with some inductive elements such as boost power conversion system, buck power conversion system, buck-boost power conversion system, and power factor correction power conversion system.

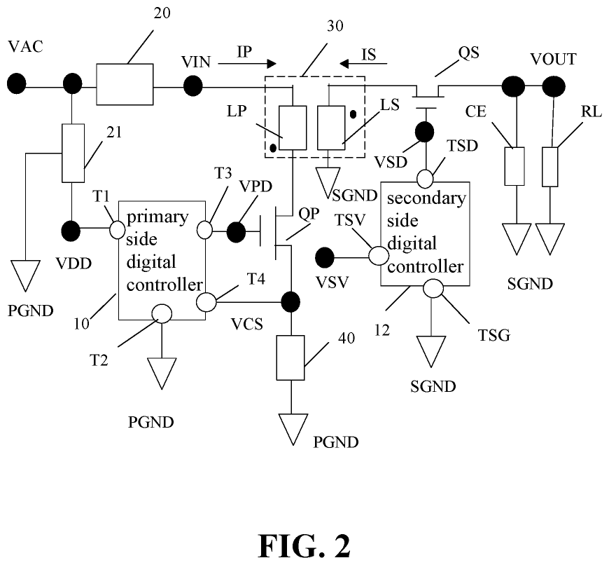

More specifically, refer to FIG. 2 showing the functional blocks of the power conversion system employed by the method according to the embodiment of the present invention. The power conversion system is the flyback power conversion system with synchronous rectification substantially comprising a primary side digital controller 10, a secondary side digital controller 12, a rectification unit 20, a power unit 21, a transformer unit 30, a primary side switch unit QP, a current sensing unit 40, a secondary side switch unit QS, and a secondary side output capacitor CE. In particular, the primary side digital controller 10 is configured to perform the steps S10, S20, S30, S40, S50, S52, S54, S56, S60, S62, S64, S66, S70, S72, S74, and S76 mentioned-above, and has a primary side power pin T1, a primary side ground pin T2, a primary side driving pin T3S and a primary side current sensing pin T4. The secondary side digital controller 12 comprises a secondary side driving pin TSD, a secondary side ground pin TSG, and a secondary side power pin TSV.

Further, the transformer unit 30 comprises a primary side winding LP and a secondary side winding LS coupled with each other. Each of the primary side switch unit QP and the secondary side switch unit QS comprises a Metal-Oxide-Semiconductor (MOS), a Gallium Nitride (GaN) Field Emitted Transistor (FET), or a SiC-MOSFET.

The rectification unit 20 receives an external input power VAC to generate and deliver a rectification power VIN through rectification, and the power unit 21 receives the external input power to generate and deliver a power voltage VDD. The primary side power pin T1 receives the power voltage VDD to supply the primary side digital controller 10 to operate. Similarly, the secondary side digital controller 12 employs the secondary side power pin TSV to receive the power voltage VDD from the power unit 21 as a secondary side power voltage VSV, or alternatively, a secondary side power unit (not shown) similar to the power unit 21 is additionally provided to supply the secondary side digital controller 12 to operate. Since the power unit 21 and the secondary side power unit are commonly used in the prior arts, the detailed description is not mentioned hereinafter.

In addition, the primary side ground pin T2 of the primary side digital controller 10 is connected to a primary side ground level PGND, and the secondary side ground pin TSG of the secondary side digital controller 12 is connected to a secondary side ground level SGND. The primary side ground level PGND and the secondary side ground level SGND are configured to have the same level or different levels depending on the actual application.

An end of the primary side winding LP is connected to the rectification unit 21 for receiving the rectification power VIN, the drain of the primary side switch unit QP is connected to the other end of the primary side winding LP, and the gate of the primary side switch unit QP is connected to the primary side driving pin T3 of primary side digital controller 10. The source of the primary side switch unit QP is connected to the primary side current sensing pin T4 of the primary side digital controller 10. An end of the current sensing unit 40 is connected to the primary side current sensing pin T4, and the other end of the current sensing unit 40 is connected to the primary side ground level PGND. The primary side current sensing pin T4 generates and delivers a current sensing signal VCS through the primary side current sensing pin T4.

Further, the primary side digital controller 10 receives the current sensing signal VCS through the primary side current sensing pin T4 to generate and deliver a primary side driving signal VPD to the gate of the primary side switch unit QP through the primary side driving pin T3 so as to turn on and off the primary side switch unit QP, thereby implementing switch control and change a primary side current IP flowing through the primary side winding LP, Moreover, the primary side driving signal VPD is substantially a Pulse Width Modulation (PWM) signal with a PWM frequency, and has a turn-on level and a turn-off level periodically interlacing for periodically turning on and off the primary side switch unit QP to change the primary side current IP.

At the secondary side, an end of the secondary side winding LS is connected to the drain of the secondary side switch unit QS, the other end of the secondary side winding LS is connected to the secondary side ground level SGND, the gate of the secondary side switch unit QS is connected to the secondary side driving pin TSD of the secondary side digital controller 12, the source of the secondary side switch unit QS is connected to an end of the secondary side output capacitor CE and an end of the load RL, and the other end of the secondary side output capacitor CE and the other end of the load RL are connected to the secondary side ground level SGND. In particular, the source of the secondary side switch unit QS serves as the output power terminal to generate the output power VOUT for supplying the load RL. In other words, the source of the secondary side switch unit QS is the output power terminal as desired.

Also, the secondary side winding LS generates a secondary side current IS by electromagnetic interaction with the primary side winding LP and flows through the secondary side switch unit QS to the secondary side output capacitor CE and the load RL via the control of the secondary side digital controller 12. And the secondary side output capacitor CE and the load RL are connected in parallel and then connected in series to the secondary side switch unit QS.

As a whole, the rectification unit 20, the primary side winding LP of the transformer unit 30, the primary side switch unit QP, and the current sensing unit 40 are connected to form a primary side loop, and the primary side digital controller 10 turn on and off the primary side switch unit QP to control the conduction current flowing through the primary loop. On the other hand, the secondary side winding LS of the trans former unit 30, the secondary side switch unit QSs and the secondary side output capacitor CE are connected to form a secondary side loop, and the secondary side digital controller 12 turn on and off the secondary side switch unit QS to control the conduction current flowing through the secondary loop, thereby implementing synchronous rectification. Then, the secondary side output capacitor CE generates the output power VOUT for supplying the load RL to operate.

In other words, the primary side digital controller 10 controls the current flowing through the primary loop for the transformer 30 to induce the current flowing through the secondary loop due to electromagnetic interaction, and the secondary side digital controller 12 is in collocation with the primary side digital controller 10 and the transformer 30.

Furthermore, the secondary side digital controller 12 employs the secondary side current IS or the drain-source voltage of the secondary side switch unit QS to generate the secondary side driving signal VSD, and the secondary side driving signal VSD is further delivered to the gate of the secondary side switch unit QS through the secondary side driving pin TSD so as to control the secondary side switch unit QS to turn on and off. For example, the secondary side digital controller 12 employs the secondary side driving signal VSD to turn on the secondary side switch unit QS when the secondary side current IS is negative or flows from the secondary side winding LS to the secondary side switch unit QS, or when the drain-source voltage of the secondary side switch unit QS is positive. Also, the secondary side digital controller 12 employs the secondary side driving signal VSD to turn off the secondary side switch unit QS when the secondary side current IS is positive or flows from the secondary side switch unit QS to the secondary side winding LS, or when the drain-source voltage of the secondary side switch unit QS is negative.

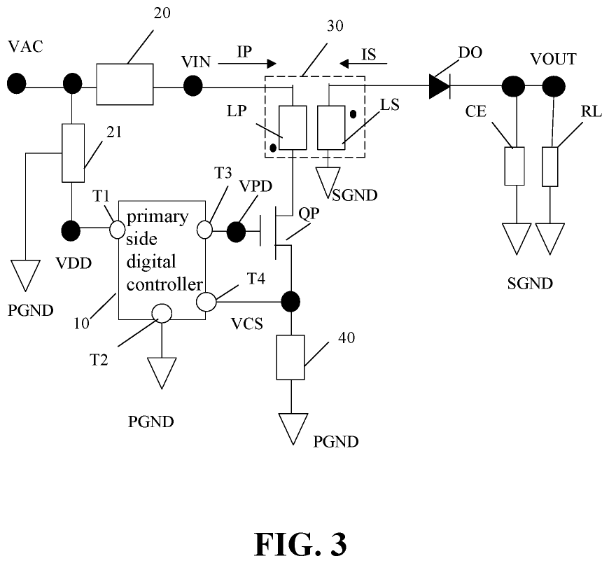

Refer to FIG. 3, another view showing the functional blocks of the power conversion system employed by the method according to the embodiment of the present invention. The power conversion system depicted in FIG. 3 is similar to the power conversion system depicted in FIG. 2, but only comprises a primary side digital controller 10, a rectification unit 20, a power unit 21, a transformer unit 30, a primary side switch unit QP, a secondary side rectification diode DO, and the current sensing unit 40. The secondary side digital controller 12 and the secondary side switch unit QS in FIG. 2 not included. The secondary side rectification diode DO intended to replace the secondary side switch unit QS. In particular, the primary side digital controller 10 is configured to perform the steps S10, S20, S30, S40, S50, S52, S54, S56, S60, S62, S64, S66, S70, S72, S74, and S76 mentioned-above, and has a primary side power pin T1, a primary side ground pin T2, a primary side driving pin T3, and a primary side current sensing pin T4. It should be noted that the primary side digital controller 10 in FIG. 3 has the same electrical connection as the primary side digital controller 10 in FIG. 2, but the power conversion system in FIG. 3 is the flyback power conversion system without synchronous rectification.

Further, a positive end of the secondary side rectification diode DO is connected to an end of the secondary side winding LS, an end of the secondary side output capacitor CE and an end of the load RL are connected to a negative end of the secondary side rectification diode DO, the other end of the secondary side winding LS, the other end of the secondary side output capacitor CE, and the other end of the load RL are connected to a secondary side ground level SGND. The negative end of the secondary side rectification diode DO serves as the output power terminal and generates the output power VOUT for supplying the load RL to operate.

Since the electrical connections of other elements in FIG. 3 are the same as the electrical connections in FIG. 2, the detailed description is not mentioned hereinafter.

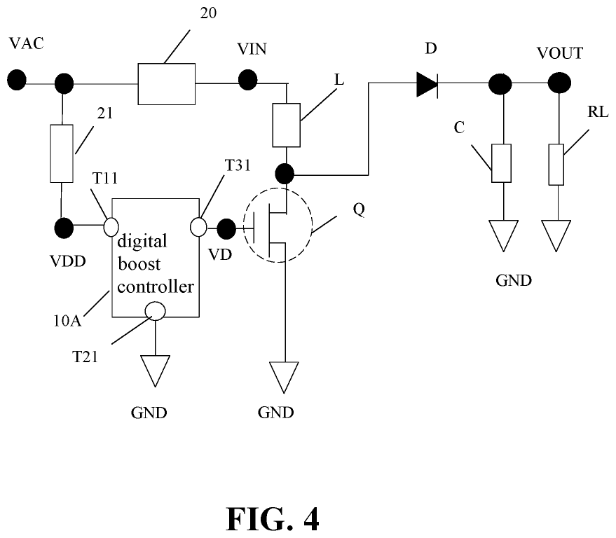

Further refer to FIGS. 4, 5, and 6 showing other illustrative examples of the power conversion system, including the boost, buck, and power factor correction (PFC) schemes, quite different from the flyback power conversion systems depicted in FIGS. 2 and 3* In other words, the operation flow in FIG. 1 is totally applicable to the power conversion systems in FIGS. 4, 5, and 6. Since the boost, buck, and PFC schemes are common in the prior arts, only brief description is mentioned hereinafter.

As shown in FIG. 4, the power conversion system employed by the method of the present invention comprises a digital boost controller 10A, a rectification unit 20, a power unit 21, a winding L, a switch unit Q, a rectification diode D, and an output capacitor C, and the digital boost controller 10A is configured to perform the steps S10, S20, S30, S40, S50, S52, S54, S56, S60, S62, S64s S66, S70, S72, S74, and S76 mentioned-above so as to implement a buck function for power conversion.

Further, the digital boost controller 10A has a power pin T11, a ground pin T21, and a driving pin T31. The power pin T11 is connected to the power unit 21, the ground pin T21 is connected to a ground level GND, and the driving pin T31 is connected to a gate of the switch unit Q to control the switch unit Q. Also, the rectification unit 20 receives the external input power VAC to generate and deliver the VIN through rectification, and the power unit 21 receives the external input power VAC to generate and deliver the power voltage VDD to supply the digital boost controller 10A.

An end of the winding L is connected to the rectification unit 20 for receiving the rectification power VIN, a drain of the switch unit Q is connected to the other end of the winding L and a positive end of the rectification diode D, and a negative end of the rectification diode D is connected to an end of the output capacitor C. A source of the switch unit Q and the end of the output capacitor C are connected to the ground level GND. The negative end of the rectification diode D serves as the output power terminal and generates the output power VOUT, an end of the load RL is connected to the negative end of the rectification diode D to receive the output power VOUT to operate, and the other end of the load RL is connected to the ground level GND.

In particular, the digital boost controller 10A generates and delivers a driving signal VD to the gate of the switch unit Q through the driving pin T31. The driving signal VD is substantially a PWM signal with a PWM frequency, and has a turn-on level and a turn-off level periodically interlacing for periodically turning on and off the switch unit Q. Additionally, the switch unit Q changes the current flowing through the winding L and the rectification diode D to the output capacitor C the load RL, The output power VOUT generated by the negative end of the rectification diode D has a voltage higher than the average voltage (root mean square voltage) of the internal power VAC, thus having an electrical feature of boost.

Overall, then power conversion system shown in FIG. 4 implements the function of boost power conversion.

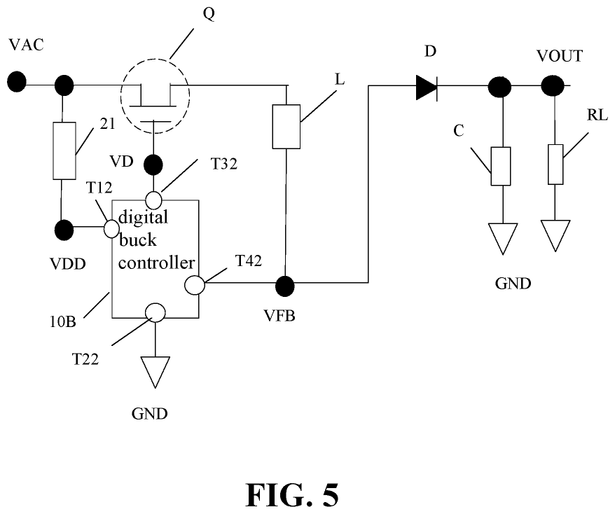

As shown in FIG. 5, the power conversion system employed by the method of the present invention comprises a digital buck controller 10B, a power unit 21, a winding L, a switch unit Q, a rectification diode D, and an output capacitor C, and the digital buck controller 10B is configured to perform the steps S10, S20, S30, S40, S50, S52, S54, S56, S60, S62, S64, S66, S70, S72, S74, and S76 mentioned-above so as to implement a buck function for power conversion.

Additionally, the digital buck controller 10B has a power pin T12, a ground pin T22, a driving pin T32, and a feedback pin T42, The power pin T12 is connected to the power unit 21, the ground pin T22 is connected to a ground level GND, and the driving pin T32 is connected to a gate of the switch unit Q to control the switch unit Q. Also, the power unit 21 receives the external input power VAC to generate and deliver the power voltage VDD to supply the digital buck controller 1 OB.

A drain of the switch unit Q receives the external input power VAC, an end of the winding L is connected to a source of the switch unit Q, and the other end of the winding L is connected to the feedback pin T42 and a positive end of the rectification diode D. Further, a negative end of the rectification diode D is connected to an end of the output capacitor C, and the other end of the output capacitor C is connected to the ground level GND.

Also, the negative end of the rectification diode D serves as the output power terminal and generates the output power VOUT, an end of the load RL is connected to the negative end of the rectification diode D to receive the output power VOUT to operate, and the other end of the load RL is connected to the ground level GND. In particular, the other end of the winding L generates and delivers a feedback signal VFB to the digital buck controller 10B through the feedback pin T42 so as to generate and deliver a driving signal VD to drive the switch unit Q, thereby controlling the current flowing the winding L and generating the output power VOUT as desired.

In particular, the digital buck controller 10B employs the feedback signal VFB to generate the driving signal VD, and the driving signal VD is further delivered to the gate of the switch unit Q through the driving pin T32. The driving signal VD is substantially a PWM signal with a PWM frequency, and has a turn-on level and a turn-off level periodically interlacing for periodically turning on and off the switch unit Q. Additionally, the switch unit Q changes the current flowing through the winding L and the rectification diode D to the output capacitor C the load RL. The output power VOUT generated by the negative end of the rectification diode D has a voltage lower than the average voltage (root mean square voltage) of the internal power VAC, thus having an electrical feature of buck.

Overall, then power conversion system shown in FIG. 5 implements the function of buck power conversion,

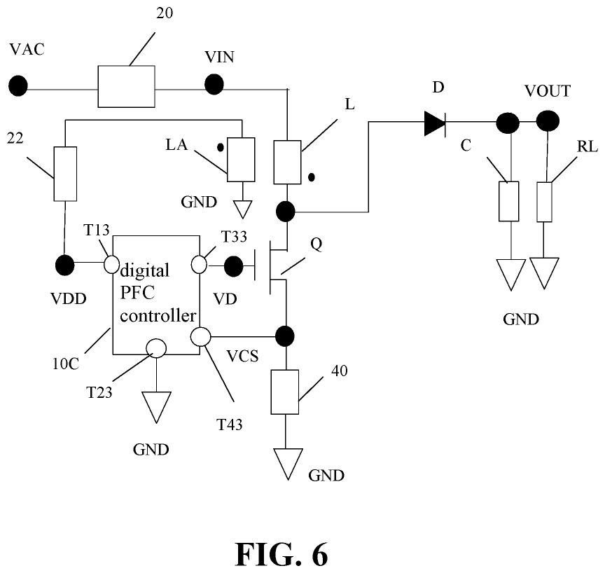

As shown in FIG. 6, the power conversion system employed by the method of the present invention comprises a digital Power Factor Correction (PFC) controller 10C, a rectification unit 20, an auxiliary resistor 22, a winding L, an auxiliary winding LA, a switch unit Q, a current sensing unit 40, a rectification diode D, and an output capacitor C, and the digital PFC controller IOC is configured to perform the steps S10, S20, S30, S40, S50, S52, S54, S56, S60, S62s S64, S66, S70, S72, S74, and S76 mentioned-above so as to implement a PFC function for power conversion.

In addition, the digital PFC controller 10C has a power pin T13, a ground pin T23, a driving pin T33, and a current sensing pin T43, The ground pin T23 is connected to a ground level GND, and the driving pin T33 is connected to a gate of the switch unit Q to control the switch unit Q. Particularly, the auxiliary winding LA is electromagnetically coupled with the winding L, an end of the auxiliary winding LA is connected to the ground level GND, the other end of the auxiliary winding LA is connected to an end of the auxiliary resistor 22, and the other end of the auxiliary resistor 22 is connected to the power pin T13. Also, the auxiliary winding LA induces an induced voltage through interaction with the winding L, and the other end of the auxiliary resistor 22 generates the power voltage VDD to supply the digital PFC controller 10C to operate.

The above rectification unit 20 receives an external input power VAC to generate a rectification power YIN.

Further, an end of the winding L is connected to the rectification unit 20 for receiving the rectification power VIN, the drain of the switch unit Q is connected to the other end of the winding L and a positive end of the rectification diode D, and a negative end of the rectification diode D is connected to an end of the output capacitor C. The current sensing pin T43 is connected to the source of the switch unit Q and an end of the current sensing unit 40, and the other end of the current sensing unit 40 is connected to the ground level GND. The source of the switch unit Q generates a current sensing signal VCS, and the current sensing signal VCS is further delivered to the current sensing pin T43 for the digital PFC controller 10C to the driving pin T33, thereby correctly turning on and off the switch unit Q.

Also, the negative end of the rectification diode D serves as the output power terminal to generate the output power VOUT, and an end of the load RL is connected to the negative end of the rectification diode D to receive the output power VOUT to operate. The other end of the load RL is connected to the ground level GND.

In particular, the digital PFC controller 10C employs the current sensing signal VCS to generate a driving signal VD, and the driving signal VD is further delivered to the gate of the switch unit Q through the driving pin T33. The driving signal VD is substantially a PWM signal with a PWM frequency, and has a turn-on level and a turn-off level periodically interlacing for periodically turning on and off the switch unit Q. Additionally, the switch unit Q changes the current flowing through the winding L and the rectification diode D to the output capacitor C the load RL. Under control of the digital PFC controller 10C, the output power VOUT generated by the negative end of the rectification diode D has an electrical feature of PFC.

Overall, then power conversion system shown in FIG. 6 implements the function of PFC power conversion.

For example, the above-mentioned switch unit Q comprises a Metal-Oxide-Semiconductor (MOS), a Gallium Nitride (GaN) Field Emitted Transistor (FET), or a SiC-MOSFET.

It should be noted that the method of the present invention is also applicable to a buck-boost power conversion system, and the detailed description is omitted because the buck-boost power conversion system is common in the prior arts.

Therefore, the aspect of the present invention is that not only power conversion is provided, but the primary side digital controller can also power down to greatly reduce power consumption and effectively implement power saving while the power conversion system is at the standby state. In particular, the present invention determines to enter the standby mode based on the loading level so as to select the no-load mode, the sleep mode, or the power-down mode as the standby mode, and the power conversion system is controlled to deliver the no-load sustaining power or the sleep sustaining power, or just cease the output power to the output power terminal. The no-load wake-up detection mode, the sleep wake-up detection mode, and the power-down wake-up detection mode are further provided to return back to the normal operation mode from the no-load mode, the sleep mode, and the power-down mode.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of standby power supply for implementing power conversion and power supply for standby, comprising:
a step (S10) of employing a power conversion system to generate and deliver an operation power as an output power through an output power terminal of the power conversion system, and detecting a loading level applied to the output power terminal;
a step (S20) performed after the step SI0 by determining the loading level and a period of time as a standby sustaining time when the loading level is not greater than a standby loading, and examining if the standby sustaining time reaches a standby time;
a step (S30) performed after the step S20 by entering a select mode when the standby sustaining time reaches the standby time; a step (S40) performed after the step S30 by checking if a load is connected to the output power terminal or the load is disconnected from the output power terminal, further determining if the load connected has a standby power requirement, and selecting a no-load mode, a sleep mode, or a power-down mode as a standby mode, the no-load mode being selected in case of the load disconnected from the output power terminal, the sleep mode being selected in case of the load connected having the standby power requirement, the power-down mode being selected in case of the load connected not having the standby power requirement; a step (S50) performed after the step S40 by executing the no-load mode when the load being disconnected from the output power terminal;
a step (S52) performed after the step S50 by driving the power conversion system to generate and deliver a no-load sustaining power less than the operation power to the output power terminal, and entering a no-load wake-up detecting mode;
a step (S54) performed after the step S52 by executing the no-load wake-up detecting mode to detect if the loading level is not less than a no-load wake-up level, a no-load recovery mode being performed in case of the loading level not less than the no-load wake-up level and sustaining for more than a no-load wake-up time;
a step (S56) performed after the step S54 by executing the no-load recovery mode to drive the power conversion system to generate and deliver the operation power, and then return back to the step S10; a step (S60) performed after the step S40 by executing the sleep mode when the load connected having the standby power requirement; a step (S62) per formed after the step S60 by driving the power conversion system to generate and deliver a sleep sustaining power less than the operation power to the output power terminal, and entering a sleep wake-up detecting mode;
a step (S64) performed after the step S62 by executing the sleep wake-up detecting mode to detect if the loading level is not less than a sleep wake-up level, a sleep recovery mode being performed in case of the loading level not less than the sleep wake-up level and sustaining for more than a sleep wake-up time;
a step (S66) performed after the step S64 by executing the sleep recovery mode to drive the power conversion system to generate and deliver the operation power, and then return back to the step S10; a step (S70) performed after the step S40 by executing the power-down mode when the load connected not having the standby power requirement; a step (S72) performed after the step S70 by ceasing the operation power to the output power terminal, and entering a power-down wake-up detecting mode, and entering a power-down wake-up detecting mode; a step (S74) performed after the step S72 by executing the power-down wake-up detecting mode to detect if the loading level is not less than a power-down wake-up level, a power-down recovery mode being performed in case of the loading level not less than the power-down wake-up level and sustaining for more than a power-down wake-up time; and a step (S76) performed after the step S74 by executing the power-down recovery mode to drive the power conversion system to generate and deliver the operation power, and then return back to the step S10, wherein the standby loading is 1 to 5% of a full loading, the standby time is 0.1 to 10 milliseconds, the no-load sustaining power is 0.1 to 10% of the operation power, the sleep sustaining power is not less than the no-load sustaining power, the no-load wake-up level is 1 to 5% of the full loading, the sleep wake-up level is 1 to 5% of the foil loading, the power-down wake-up level is 1 to 5% of the full loading, the no-load wake-up time is 1 to 10 seconds, the sleep wake-up time is 1 to 10 seconds, and the power-down wake-up time is 1 to 10 seconds.

2. The method as claimed in claim 1, wherein the power conversion system comprises:
a primary side digital controller configured to perform the steps S10, S20, S30, S40, S50, S52, S54, S56, S60, S62, S64, S66, S70, S72, S74, and S76, and comprising a primary side power pin, a primary side ground pin, a primary side driving pin, and a primary side current sensing pin, the primary side ground pin connected to a primary side ground level; a secondary side digital controller comprising a secondary side power pin, a secondary side ground pin, and a secondary side driving pin, the secondary side ground pin connected to a secondary side ground level; a rectification unit receiving an external input power to generate and deliver a rectification power through rectification; a power unit receiving the external input power to generate a power voltage, the primary side power pin connected to the power unit for receiving the power voltage to supply the primary side digital controller, the secondary side power pin connected to the power unit for receiving the power voltage as a secondary side power voltage;
a trans former unit comprising a primary side winding and a secondary side winding electromagnetically coupled together, an end of the primary side winding connected to the rectification unit for receiving the rectification power;
a primary side switch unit having a drain, a gate and a source, the drain connected to the other end of the primary side winding, the gate connected to the primary side driving pin;
a current sensing unit, the primary side current sensing pin and the source of the primary side switch unit connected to an end of the current sensing unit, the other end of the current sensing unit connected to the primary side ground level, the primary side current sensing pin generating and delivering a current sensing signal to the primary side digital controller through the primary side current sensing pin; a secondary side switch unit having a drain, a gate, and a source; and a secondary side output capacitor,
wherein the drain of the secondary side switch unit is connected to an end of the secondary side winding, the other end of the secondary side winding is connected to the secondary side ground level, the gate of the secondary side switch unit is connected to the secondary side driving pin, the source of the secondary side switch unit is connected to an end of the secondary side output capacitor and an end of the load, the other end of the secondary side output capacitor and the other end of the load are connected to the secondary side ground level, the source of the secondary side switch unit serves as the output power terminal to generate the output power for supplying the load, the primary side digital controller receives the current sensing signal through the primary side current sensing pin to generate and deliver a primary side driving signal to the gate of the primary side switch unit, the primary side driving signal is a Pulse Width Modulation (PWM) signal with a PWM frequency, and has a turn-on level and a turn-off level periodically interlacing for periodically turning on and off the primary side switch unit to change a primary side current flowing through the primary side winding, the secondary side digital controller employs the secondary side current or the drain-source voltage of the secondary side switch unit to generate the secondary side power voltage, the secondary side power voltage is delivered to the gate of the secondary side switch unit through the secondary side driving pin so as to control the secondary side switch unit to turn on and off, the secondary side winding generates a secondary side current by electromagnetic interaction with the primary side winding, the secondary side current flows through the secondary side switch unit to the secondary side output capacitor and the load, and the secondary side output capacitor and the load are connected in parallel and then connected in series to the secondary side switch unit.

3. The method as claimed in claim 2, wherein each of the primary side switch unit and the secondary side switch unit comprises a Metal-Oxide-Semiconductor (MOS), a Gallium Nitride (GaN) Field Emitted Transistor (FET), or a SiC-MOSFET.

4. The method as claimed in claim 1, wherein the power conversion system comprises:
a primary side digital controller configured to perform the steps S10, S20, S30, S40, S50, S52, S54, S56, S60, S62, S64, S66, S70, S72, S74, and S76, and comprising a primary side power pin, a primary side ground pin, a primary side driving pin, and a primary side current sensing pin, the primary side ground pin connected to a primary side ground level; a rectification unit receiving an external input power to generate and deliver a rectification power through rectification;
a power unit receiving the external input power to generate a power voltage, the primary side power pin connected to the power unit for receiving the power voltage to supply the primary side digital controller; a transformer unit comprising a primary side winding and a secondary side winding electromagnetically coupled together, an end of the primary side winding connected to the rectification unit for receiving the rectification power;
a primary side switch unit having a drain, a gate, and a source, the drain connected to the other end of the primary side winding, the gate connected to the primary side driving pin;
a current sensing unit, the primary side current sensing pin and the source of the primary side switch unit connected to an end of the current sensing unit, the other end of the current sensing unit connected to the primary side ground level, the primary side current sensing pin generating and delivering a current sensing signal to the primary side digital controller through the primary side current sensing pin; a secondary side rectification diode, a positive end of the secondary side rectification diode connected to an end of the secondary side winding; and a secondary side output capacitor, an end of the secondary side output capacitor and an end of the load connected to a negative end of the secondary side rectification diode, the other end of the secondary side winding, the other end of the secondary side output capacitor, and the other end of the load connected to a secondary side ground level, the negative end of the secondary side rectification diode serving as the output power terminal and generating the output power for supplying the load,
wherein the primary side digital controller generates and delivers a primary side driving signal through the primary side current sensing pin to the gate of the primary side switch unit, the primary side driving signal is a Pulse Width Modulation (PWM) signal with a PWM frequency, and has a turn-on level and a turn-off level periodically interlacing for periodically turning on and off the primary side switch unit to change a primary side current flowing through the primary side winding, the secondary side winding generates a secondary side current by electromagnetic interaction with the primary side winding, and the secondary side current flows through the secondary side rectification diode to the secondary side output capacitor and the load.

5. The method as claimed in claim 4, wherein the primary side switch unit comprises a MOS, a GaN FET; or a SiC-MOSFET.

6. The method as claimed in claim 1, wherein the power conversion system comprises:
a digital boost controller configured to perform the steps S10, S20, S30, S40, S50, S52, S54, S56, S60, S62, S64, S66, S70, S72, S74, and S76 to implement a boost power conversion, and comprising a power pin, a ground pin, and a driving pin, the ground pin connected to a ground level;
a rectification unit receiving an external input power to generate and deliver a rectification power through rectification; a power unit receiving the external input power to generate a power voltage, the power pin connected to the power unit for receiving the power voltage to supply the digital boost controller;
a winding, an end of the winding connected to the rectification unit for receiving the rectification power;
a switch unit having a drain, a gate, and a source, the drain connected to the other end of the winding, the gate connected to the driving pin, the source connected to the ground level;
a rectification diode, a positive end of the rectification diode connected to the drain; and
an output capacitor, an end of the output capacitor and an end of the load connected to a negative end of the rectification diode, the other end of the output capacitor and the other end of the load connected to the ground level, the negative end of the rectification diode serving as the output power terminal and generating the output power for supplying the load,
wherein the digital boost controller generates and delivers a driving signal to the gate of the switch unit through the driving pin, and the driving signal is a Pulse Width Modulation (PWM) signal with a PWM frequency, and has a turn-on level and a turn-off level periodically interlacing for periodically turning on and off the switch unit for implementing boost power conversion.

7. The method as claimed in claim 1, wherein the power conversion system comprises:
a digital buck controller configured to perform the steps S10, S20, S30, S40, S50, S52, S54, S56, S60, S62, S64, S66, S70, S72, S74, and S76 to implement a buck conversion, and comprising a power pin, a ground pin, a driving pin, and a feedback pin, the ground pin connected to a ground level;
a power unit receiving an external input power to generate a power voltage, the power pin connected to the power unit for receiving the power voltage to supply the digital buck controller; a winding;
a switch unit having a drain, a gate, and a source, the source connected to an end of the winding, the drain receiving the external input power, the driving pin connected to the gate to drive the switch unit, the other end of the winding connected to the feedback pin;
a rectification diode, a positive end of the rectification diode connected to the feedback pin; and
an output capacitor, an end of the output capacitor and an end of the load connected to a negative end of the rectification diode, the other end of the output capacitor and the other end of the load connected to the ground level, the negative end of the rectification diode serving as the output power terminal and generating the output power for supplying the load, the other end of the winding generating and delivering a feedback signal to the digital buck controller through the feedback pin, wherein the digital buck controller employs the feedback signal to generate and deliver a driving signal to the gate of the switch unit through the driving pin, and the driving signal is a Pulse Width Modulation (PWM) signal with a PWM frequency, and has a turn-on level and a turn-off level periodically interlacing for periodically turning on and off the switch unit for implementing buck power conversion.

8. The method as claimed in claim 1, wherein the power conversion system comprises:
a digital Power Factor Correction (PFC) controller configured to perform the steps S10, S20, S30, S40, S50, S52, S54, S56, S60, S62, S64, S66, S70, S72, S74, and S76, and comprising a power pin, a ground pin, a driving pin, and a current sensing pin, the power pin receiving a power voltage, the ground pin connected to a ground level;
a rectification unit receiving an external input power to generate and deliver a rectification power through rectification; a winding, an end of the winding connected to the rectification unit for receiving the rectification power;
an auxiliary winding electromagnetically coupled with the winding, an end of the auxiliary winding connected to the ground level, the other end of the auxiliary winding connected to an end of an auxiliary resistor, the other end of the auxiliary resistor connected to the power pin, the other end of the auxiliary resistor generating the power voltage through electromagnetic interaction with winding to supply the digital PFC controller; a switch unit having a drain, a gate, and a source, the drain connected to the other end of the winding, the gate connected to the driving pin, the source connected to the current sensing pin to generate a current sensing signal; a current sensing unit, the current sensing pin connected to an end of the current sensing unit, the other end of the current sensing unit connected to the ground level;
a rectification diode, a positive end of the rectification diode connected to the drain; and
an output capacitor, an end of the output capacitor and an end of the load connected to a negative end of the rectification diode, the other end of the output capacitor and the other end of the load connected to the ground level, the negative end of the rectification diode serving as the output power terminal and generating an output power for supplying the load,
wherein the digital PFC controller generates and delivers a driving signal to the gate of the switch unit through the driving pin, and the driving signal is a Pulse Width Modulation (PWM) signal with a PWM frequency, and has a turn-on level and a turn-off level periodically interlacing for periodically turning on and off the switch unit for implementing PFC power conversion.
